(19) United States
(12) Patent Application Publication
(10) Pub. No.: US 2018/0013755 A1
(43) Pub. Date: Jan. 11, 2018

(54) LOGON USING MASTER PASSWORD OR TURN-VARYING PASSWORD

(71) Applicant: Microsoft Technology Licensing, LLC, Redmond, WA (US)

(72) Inventor: Amer Hassan, Kirkland, WA (US)

(73) Assignee: Microsoft Technology Licensing, LLC, Redmond, WA (US)

(21) Appl. No.: 15/205,824

(22) Filed: Jul. 8, 2016

(51) Int. Cl. H04L 29/06; G06F 3/0482; G06F 3/0484; H04W 12/12

(52) U.S. Cl. CPC H04L 63/0838; H04W 12/12; H04L 63/1466; G06F 3/0482; G06F 3/0484; H04L 63/10

(57) ABSTRACT

Embodiments utilize two types of passwords that each, separately, allow a device user to logon to a network. The first is a master password that allows a user to log on at any time. The second is a turn-varying password that changes with each logon and is valid for only one logon. The network may be accessed by using either the master password or the turn-varying password. The turn-varying password may be presented to a user at the device. A device and a network apparatus may each initially synchronize and maintain a turn state that is based on a number of user logons. When a logon occurs, the device and network apparatus update the turn-varying password for the next logon using the turn-varying password. If a user is in an unsecure location and logs on only using the turn-varying password, a sniffed or stolen turn-varying password is not useable.

### BACKGROUND

Computer device users, particularly wireless device users who travel, must constantly be vigilant in avoiding situations in which their network logon passwords or passwords for a service may be stolen. Password theft is a particular concern when a device user travels and may need to access services of a network through various visited Wi-Fi networks, such as public Wi-Fi networks, or Wi-Fi networks in hotels or at airports. These types of Wi-Fi networks may not encrypt data traffic and may be vulnerable to sniffer software that intercepts and extracts information from communications on the network. The prevalence of these types of networks also may encourage hackers to set up rogue Wi-Fi hotspots in Wi-Fi network areas where large numbers of users are likely to be searching for a connection. A user may connect to a rogue Wi-Fi hotspot at which point their personal information, such as passwords, may be collected and compromised.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

The embodiments of the disclosure include devices, apparatus, and methods that allow a device user to logon to a network providing a service by selectively using one of two passwords, where one of the two passwords may be changed at each logon for security purposes. Each of the two passwords used alone allows the device user to logon to the network. A first password of the two passwords may be a master password that allows a user to log on at any time. The second of the two passwords may be a turn-varying password that may be changed to an updated iteration at least with each logon using the turn-varying password. An iteration of the turn-varying password may be valid for use for only one logon. In the embodiments, a network may be accessed by using either of the master password or the turn-varying password depending on a user's choice. If the user is connecting to the service of the network through another network such as a public or unsecure visited Wi-Fi network, the user may choose to use the turn-varying password. If the user is connecting to the service of the network through another network that is a secure network, such a work Wi-Fi network, the user may choose to use the master password.

An example implementation includes a device configured to receive input at a user interface of the device. The input may include an input indicating that one of a turn-varying password or a master password will be used for accessing a network. The input may comprise the turn-varying password or the master password as entered at the user interface. The device sends a signal including one of either the turn-varying password or the master password to access the network. Next, the device receives access to the network based on the one of the turn-varying password or the master password included in the signal being valid. After receiving access to the network, if the network was accessed based on the turn varying-password being included in the signal to access the network, the device updates a turn state in the device. A new turn-varying password may now be generated based on the updated state. The user may use the new turn-varying password for a next logon to the network. The turn state in the device may be associated with a number of logons to the network and may be synchronized with a turn state in the network. The synchronization of the turn state in the device with the turn state in the network allows the network to generate the same new turn-varying password as generated in the device. The turn-varying password included in the signal sent to the network to logon to the service network may be now considered invalid, and the new turn-varying password is the only time-varying password that will allow access to the network. Another example implementation includes a device configured to receive a request at the user interface for the turn-varying password that is current for the next logon, and, in response to the request, provide the turn-varying password to a user at the user interface. For example, the turn-varying password may be displayed to the user so the user may enter the turn-varying password into the device for logon.

Another example implementation includes an apparatus in a network that stores a turn-varying password and a master password associated with a particular user's account. The apparatus may be configured receive a signal, where the signal includes one of the turn-varying password or the master password for access to the network. Upon receiving the signal, the apparatus grants the device access to the network based on the one of the turn-varying password or the master password in the signal being valid. Then, if the network was accessed based on the turn-varying password being valid, the apparatus updates a turn state in the apparatus. The apparatus may then generate a new turn varying password based on the updated turn state while maintaining the master password as prior to the logon. The turn state in the apparatus may be associated with a number of logons to the network by the user with the device, and may be synchronized with a turn state in the device to allow the device to generate the same new turn-varying password as generated in the apparatus. The turn-varying password included in the signal received by the apparatus may be now considered invalid, and the new turn-varying password is the only time-varying password that will cause the apparatus to grant the device access to the network.

### BRIEF DESCRIPTION OF THE DRAWINGS

FIG. 1A is a simplified diagram illustrating portions of an example device and an example network apparatus;

FIG. 1B illustrates an example database for generating turn-varying passwords;

FIG. 1C illustrates example circuitry for generating turn-varying passwords;

FIG. 2A is a flow diagram illustrating operations performed in an example device;

FIG. 2B is a flow diagram illustrating operations performed by an example apparatus in a network;

FIG. 3A is a flow diagram illustrating operations performed in a device/apparatus using the example circuitry of FIG. 1C;

FIG. 3B is flow diagram illustrating operations performed in a device/apparatus using the example database of FIG. 1B;

FIG. 4 is a simplified block diagram illustrating an example device; and,

FIG. 5 is a simplified block diagram illustrating an example apparatus in a network.

### DETAILED DESCRIPTION

The system and method will now be described by use of example embodiments. The example embodiments are presented in this disclosure for illustrative purposes, and not intended to be restrictive or limiting on the scope of the disclosure or the claims presented herein.

The embodiments of the disclosure provide a user of a device an additional level of password security when logging on to a network or service from the device. The additional level of password security is implemented by providing the user an option to logon to the network or service with either a master password or a turn varying password. The user may select to logon from the device using the turn-varying password in logon situations in which more secure password protection is desirable.

For example, a user of a mobile device implemented according to the embodiments may be in a situation away from their workplace or home where the user's communications, including logon passwords, are vulnerable to theft. For example, the user may need to logon to access services of a network or service, such as a work network or a personal email account, through a visited Wi-Fi network, such as a public Wi-Fi network, or a Wi-Fi network in a hotel or at an airport. The Wi-Fi network may not encrypt data traffic and the user may be concerned that transmissions to the network may be vulnerable to sniffer software that intercepts and extracts information from the user's transmissions. The user may also be concerned that they may inadvertently connect to a counterfeit or rogue Wi-Fi access point. That rogue Wi-Fi access point could then collect and compromise the user's personal information, such as passwords. In this situation, the user of the device may decide to logon to the visited Wi-Fi network using the turn-varying password for additional security. Here, the availability of the option to select the turn-varying password for logon prevents the user from having to expose their master password in the visited Wi-Fi network. If the turn-varying password is intercepted, because the turn-varying password is valid for only a single logon (i.e., the turn-varying password is changed at least after every successful logon that uses the turn varying password) the intercepted version of the turn-varying password is of no use to a third party. In other situations, such as when the user is in their workplace using secure encrypted Wi-Fi network, they may select to logon to the network, or logon to other services through the network, by using the master password.

In the embodiments, the ability to logon from a device using either the master password or turn-varying password does not hinder a user's flexibility in accessing a network. For example, a user may have a work or personal mobile device that they use for travel. The mobile device of the user and a particular network from which the user accesses services may each be configured with capability to use and process both the master password and the turn-varying password according to the embodiments. When the user travels with the work or personal mobile device the user may select to logon using the turn-varying password. However, the user still has the option to logon from anywhere using the master password. For example, if the user loses their work or personal mobile device while traveling and needs to logon from a visited secure computer that is not configured to use the turn-varying password, the user may use the master password to logon to the network. Also, the embodiments allow users flexibility in choosing and configuring devices. For example, a user may access the same account from various devices and may have some devices, such as mobile devices, each configured to use a turn-varying password and some devices, such as desktop computers, not configured to use the turn-varying password.

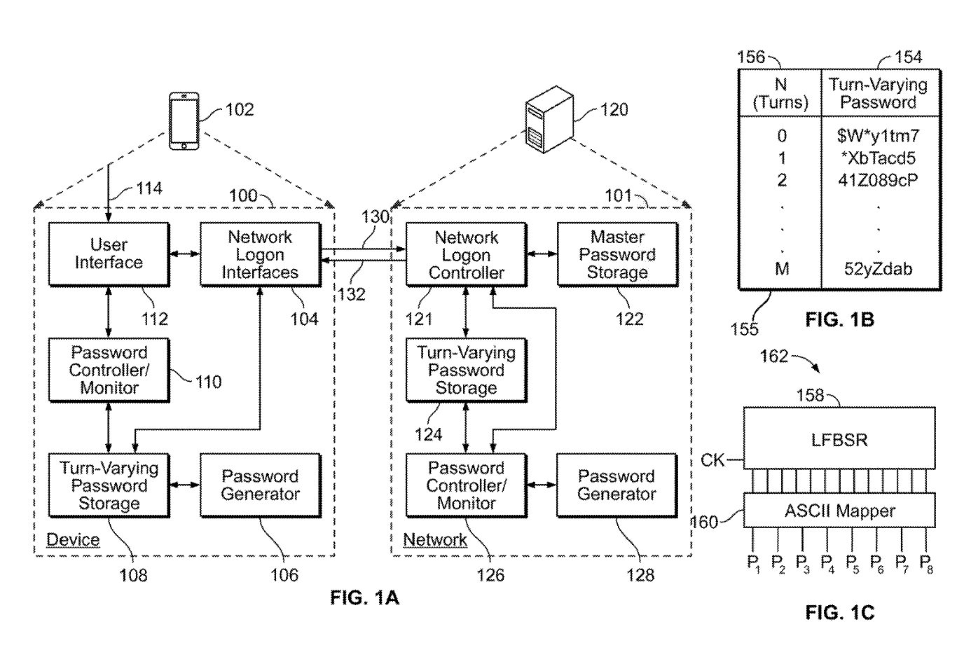

FIG. 1A is a simplified diagram illustrating portions of an example device 102 and an example apparatus 120. FIG. 1A shows a portion 100 of device 102 that includes functions that may be used to logon to a network according to an implementation of the disclosed embodiments. FIG. 1A also shows a portion 101 of apparatus 120 that includes functions that may be configured within the network to interact with device 102 and implement logon using turn-varying passwords. Device 102 and apparatus 120 may include other functions than those shown in portion 100 and portion 101, depending on the type of device or network. While device 102 is shown as an example smart phone, device 102 may be implemented as any other type of mobile device or computing device that a user may use to logon to a network or service such as a laptop computer, tablet computing device, etc. While apparatus 120 is shown as an example server apparatus, apparatus 120 may be implemented as any type of computing apparatus or system that may be configured to control user logon to a network. Portion 100 of device 102 includes network logon interfaces 104, password generator 106, turn-varying password controller 108, turn-varying password storage 110, and user interface 112. Portion 101 of apparatus 120 includes network logon controller 121, password generator 128, password controller/monitor 126, turn-varying password storage 124, and master password storage 122. Apparatus 120 may be implemented to control logon for any type of network or service that may be logged using a password. For example, apparatus 120 may control logon for a work network, a commercial website, an organization's website, a social website, a personal email network, or any other password accessible network or service.

FIG. 1B shows an example database 155 that may he implemented in password generators 106 and 128 in device 102 and apparatus 120, respectively. Database 155 may comprise a look up table that includes a plurality of turn-varying passwords 154, each associated with a value of N indicating a number of logons using a turn-varying password. FIG. 1C illustrates an alternative implementation of password generators 106 and 128. FIG. 1C shows circuitry 162 for generating turn-varying passwords that includes linear feedback shift register (LFBSR) 158 and ASCII mapper 160. LFBSR 158 is cycled by a clock signal CK. Signal CK may cycle LFBSR 158 at each logon using a turn-varying password. ASCII mapper 160 generates a password P₁-P₈ based on a current turn state of LFBSR 158.

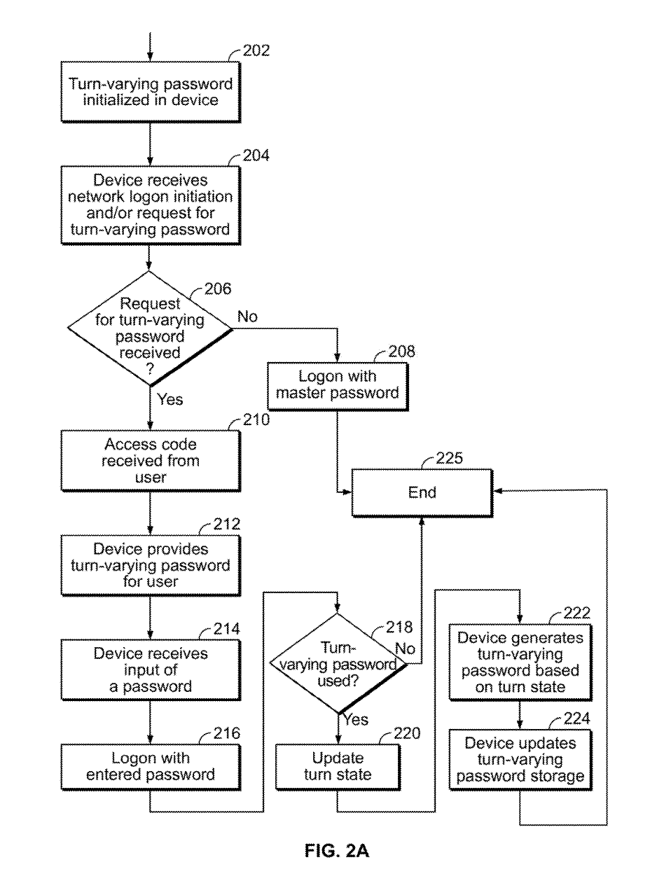

FIG. 2A is a flow diagram illustrating operations performed in an example device such as device 102 when logging onto a network. The operation of the functions of device 102 shown in FIG. 1A may be described in relation to FIG. 2A. The process begins at 202 when password controller/monitor 110 initializes the turn-varying password in device 102. Password controller/monitor 110 may perform the initialization by initializing a turn state that keeps track of logons using the time-varying password. In an implementation in which password generator 106 is implemented as including database 155 of FIG. 1B, password controller/monitor 110 may perform the initialization of the turn state by setting the value of an index N (number of logons) to 0. Password controller/monitor 110 may then retrieve the turn-varying password 154 in database 155 that is associated with N=0 and store that password in turn-varying password storage 108. In an alternative implementation in which password generator 106 is implemented as including LFBSR 158 of FIG. 1C, the password controller/monitor 110 may perform the initialization by initializing LFBSR 158 with a seed value to initialize the state in which LFBSR 158 begins its cycle. Password controller/monitor 110 may then retrieve the turn-varying password P₁-P₈ generated on the outputs of ASCII mapper 160 and store that password in turn-varying password storage 108.

The initialization at 202 of the turn-varying password in device 102 also includes password controller/monitor 110 synchronizing with password controller/monitor 126 in network apparatus 120. This is done in order that network password controller/monitor 126 in apparatus 120 may initialize the turn-varying password stored in the network to the same initial value as the turn-varying password in device 102. For example, when password generator 106 in device 102 is implemented using database 155 of FIG. 1B, password generator 128 in apparatus 120 will include an identical database 155. In this implementation password controller/monitor 110 may synchronize with apparatus 120 by communicating with password controller/monitor 126 so that the value N is set to the same value, such as 0, in both device 102 and apparatus 120. In another example, when password generator 106 is implemented using LFBSR 158 of FIG. 1C, password generator 128 in apparatus 120 will include an identical LFBSR 158. In this implementation password controller/monitor 110 may synchronize with apparatus 120 by exchanging an initial seed value with password controller 126. The initialization at 202 may be initiated for example, by communications causing device 102 and apparatus 120 to exchange an initial value of N or an initial seed value upon initial configuration of turn-varying password capabilities. In another implementation, the initialization may be performed by setting the value N or an initial seed value manually in one or both of device 102 or apparatus 120. For example, a system administrator may manually initialize the turn varying passwords in device 102 and apparatus 120.

At 204, the user of device 102 decides to logon to network 104 and initiates logon. For example, the logon at 204 may include the user bringing up a logon web page for the network 104 at user interface 112, or activating an application on device 102 displaying a logon user interface for network 104. Also, if the user desires the additional security provided by the turn-varying password, the user may activate a function on device 102 during operation 204 by inputting user input 114 at user interface 112 to request the current time-varying password for the network from password controller/monitor 110.

Next, at 206, password controller/monitor 110 determines if a request was received at the user interface for the turn-varying password. If password controller 110 determines a request for the time-varying password has not been received, the user desires to logon to the network using the master password and the process moves to 208. At 208, device 102 receives input at the user interface 112 including the master password for accessing the network. User interface 112 provides the master password to network logon interfaces 104, and device 102 initiates sending of a signal on channel 130 that includes the master password to access the network. Device 102 also receives an access grant signal on channel 132 from the network through network interfaces 104. When the access grant is received, network interfaces 104 provide the access grant signal to appropriate functions on device 102 to allow the user to interact with the services of the network. The turn-varying password is maintained the same as it was prior to the logon at 208.

If, at 206, password controller/monitor 110 determines that a request for the time-varying password has been received the process moves to 210. At 210, password controller/monitor 110 receives an access code entered by the user at user interface 112. Next, at 212, if the access code is valid, password controller/monitor 110 retrieves the current turn-varying password from turn-varying password storage 108 and provides the turn-varying password to user interface 114 for display to the user.

Next, at 214, the user then inputs a password into user interface 114 and user interface 114 provides the password to network interfaces 104. At this point, even though the user has requested the current turn-varying password, both the turn-varying password and the master password are valid for use, and the user is still able to enter either one of the turn-varying password or a master password as the entered password for accessing the network. At 216, the user initiates logon, for example by clicking a “logon” or “send” button, device 102 initiates sending of a signal on channel 130 that includes the password entered by the user to access the network and an access grant is received from the network 130 on channel 132 by device 102 using network interfaces 104. When the access grant is received, network logon interfaces 104 provides the access grant signal to appropriate functions on device 102 to allow the user to interact with the services of the network.

At 218, password controller/monitor 110 determines if the network was accessed based on the turn-varying password being the entered password. Password controller/monitor 110 may include functions for monitoring user interface 112 and/or network logon interfaces 104 to determine when a successful logon to network 120 using the time-varying password has occurred. If the network was not accessed based on the turn-varying password being the entered password (i.e., the master password was entered) the process moves to 218 and ends. The turn-varying password is maintained the same as it was prior to the logon using the master password.

If the network was accessed based on the turn-varying password being the entered password, the process moves to 220.

At 220, password controller/monitor 110 updates a turn state that tracks the number of logons using the turn-varying password. In an implementation in which password generator 106 is implemented as including database 155 of FIG. 1B, the password controller/monitor 110 may perform the updating of the turn state at 220 by incrementing the value of N (number of logons). For example, N may be incremented by 1. In an alternative implementation in which password generator 106 is implemented as including LFBSR 158 of FIG. 1C, the password controller 108 may perform the updating of the turn state at 220 by clocking the CK input of LFBSR 158 a predetermined number of times to put LFBSR 158 into an updated state. For example, the CK input of LFBSR may be clocked once.

At 222, password controller/monitor 110 instructs password generator 106 to generate an updated turn-varying password based on the updated state. In an implementation in which password generator 106 is implemented as including database 155 of FIG. 1B, the password generator 106 may generate the updating turn-varying password by outputting the password that is associated with the incremented value of N in database 155. For, example, if the incremented value of N was 2, password generator 106 would output the updated password as 41Z089cP. In an alternative implementation in which password generator 106 is implemented as including LFBSR 158 of FIG. 1C, the password controller 108 may generate the updated turn-varying password by outputting the password as P₁-P₈ from ASCII mapper 160. In this case the turn state values fed into ASCII mapper 160 from LFBSR 158 would be the turn state values subsequent to the clocking of the CK input of LFBSR 158 performed at 220.

At 224, password controller/monitor 110 then receives the updated turn-varying password from password generator 106 and updates the turn-varying password by storing the updated turn-varying password in turn-varying password storage 108. The process then ends at 218. Because the same process used in updating the turn-varying password in device 102 is followed in network 120, a valid updated turn-varying password is then available the next time the user desires to logon to network 120 using the turn-varying password.

FIG. 2B is a flow diagram illustrating operations performed by an example network apparatus for managing device logon. The operations of FIG. 2B may be performed by a network apparatus such as apparatus 120 when managing logon of device 102 according to FIG. 2A. The operations of FIG. 2B may be described in relation to FIGS. 1A and 2A.

The process begins at 202 when password controller/monitor 126 initializes turn-varying password in apparatus 120 for the account of the user of device 102. Password controller/monitor 126 may perform the initialization by setting a turn state that keeps track of logons by the user of device 102 using the time-varying password. In an implementation in which password generator 128 is implemented as including database 155 of FIG. 1B, the password controller may perform the initialization to set the turn state by setting the value of N (number of logon) to 0. In an alternative implementation in which password generator 128 is implemented as including LFBSR 158 of FIG. 1C, the password controller/monitor 126 may perform the initialization to set the turn state by initializing LFBSR 158 with a seed value at which it begins its cycle of generating numbers. The initialization at 226 of the turn-varying password in apparatus 120 also includes password controller/monitor 126 synchronizing with password controller/monitor 110 in device 102. This is done in order that password controller/monitor 110 in device 102 may initialize the turn-varying password stored in the device to the same initial value as the turn-varying password in apparatus 120. For example, when password generator 128 is implemented using database 155 of FIG. 1B, password controller/monitor 126 may synchronize with device 102 by communicating with password controller/monitor 110 so that the value N is set to the same value, such as 0, in both apparatus 120 and device 102. In another example, when password generator 106 is implemented using LFBSR 158 of FIG. 1C, password controller/monitor 126 may synchronize with device 102 by exchanging an initial seed value with password controller/monitor 110. The turn-varying password initialized at 226 may then be stored in turn-varying password storage 124 of apparatus 120. The initialization at 226 may be initiated for example, by communications causing device 102 and apparatus 120 to exchange an initial value of N or an initial seed value upon initial configuration of turn-varying password capabilities. In another implementation, the initialization may be performed by setting the value N or an initial seed value manually in one or both of device 102 or apparatus 120. For example, a system administrator may manually initialize the turn varying passwords in device 102 and apparatus 120.

At 228, the network logon process is initiated from device 102. At 230 network logon controller 121 of apparatus 120 receives a logon signal on channel 130 from a device 102. The logon signal may include either the turn-varying password or the master password that was entered by the user of device 102.

At 232, network logon controller 121 accesses master password storage 122 to determine if the correct master password for the device user's account was received. If the entered password matches the user's master password in master password storage 122, the process moves to 234. At 234 network logon controller sends a signal on channel 132 to device 102 indicating that access to the network has been granted. The process then ends at 248. The turn-varying password is maintained the same as it was prior to the logon using the master password.

If, however, at 232, network logon controller 121 determines that the correct master password was not received the process moves to 236. At 236, network logon controller 121 accesses turn-varying password storage 124 to determine if the correct turn-varying password for the device user's account was received. If the correct turn-varying password was not received, network logon controller 121 sends a signal on channel 132 that initiates a prompt to the user of device 102 to attempt to reenter the logon password. If, however, at 236, network logon control 121 determines that the correct turn-varying password was received, the process moves to 240. At 240, network logon controller 121 sends a signal on channel 132 to device 102 indicating that access to the network has been granted.

Next, at 242, password controller/monitor 126 updates the turn state kept in apparatus 120 that tracks the number of logons by the user of device 102 to their account using the time-varying password. Password controller/monitor 126 may include functions for monitoring log on attempts using the turn-varying password and update the turn state based on the monitoring. For example, password controller/monitor 126 may exchange signals with network logon controller 121 during the logon process that allow password controller/monitor 126 to determine that a successful logon to the user's account using the turn-varying password has taken place. Password controller/monitor 126 may then, at 242, update the turn state based on the determination that a successful logon using the turn-varying password has taken place.

In an implementation in which password generator 128 is implemented as including database 155 of FIG. 1B, the password controller/monitor 126 may perform the updating of the turn state at 242 by incrementing the value of N (number of logons). In this case the value of N would represent the turn state. In an alternative implementation in which password generator 128 is implemented as including LFBSR 158 of FIG. 1C, the password controller/monitor 126 may perform the updating of the turn state at 220 by clocking the CK input of LFBSR 158 a predetermined number of times. In this case the state of the outputs of LFBSR 158 would represent the turn state.

At 244, password controller/monitor 126 instructs password generator 128 to generate an updated turn-varying password based on the updated state. In an implementation in which password generator 126 is implemented as including database 155 of FIG. 1B, the password generator 126 may generate the updated turn-varying password by outputting the password that is associated in database 155 with the incremented value of N. For, example, if the incremented value of N was 2, password generator 106 would output the updated password as 41Z089cP. In an alternative implementation in which password generator 126 is implemented as including LFBSR 158 of FIG. 1C, the password generator 126 may generate the updated turn-varying password by outputting the password as P₁-P₈ from ASCII mapper 160. In this case the values fed into ASCII mapper 160 from LFBSR 158 would be the outputs of LFBSR 158 subsequent to the cycling performed at 242.

At 246, password controller/monitor 126 then receives the updated turn-varying password from password generator 128 and updates the turn-varying password in turn-varying password storage 124. Network logon controller 121 does not change the master password and the master password is maintained the same as it was prior to the logon. The process then ends at 248. As described in relation to FIG. 2A, the same process used in updating the turn-varying password in network apparatus 120 is followed in device 102, Therefore, the updated turn-varying password in turn-varying password storage 124 is the same password as stored in turn-varying password storage 108 of device 102. The network apparatus 120 and device 102 are now synchronized for turn-varying password used. The valid turn-varying password will be available to the user of device 102 when the user desires to logon to network 120 using the turn-varying password.

In other implementations, the turn varying password in a device and network apparatus may be updated at times other than only occurrences of successful network logons using the turn-varying password. For example, the turn varying password in a device and network apparatus may be updated for each successful logon from that particular device to the network using either of the turn-varying password or the master password. In this example, the turn-varying password is still a one-time password that changes each time it is transmitted.

Also, in other implementations, a user, such as the user of device 102, may have more than one device configured to use a turn-varying password to access a network to which an apparatus, such as apparatus 120, controls logon. In this implementation, each particular device of the user may have a separate turn-varying password associated with that particular device in apparatus 120 for the user's account. The turn-varying passwords of each particular device would be separately updated upon successful logon using the turn-varying password associated with that particular device.

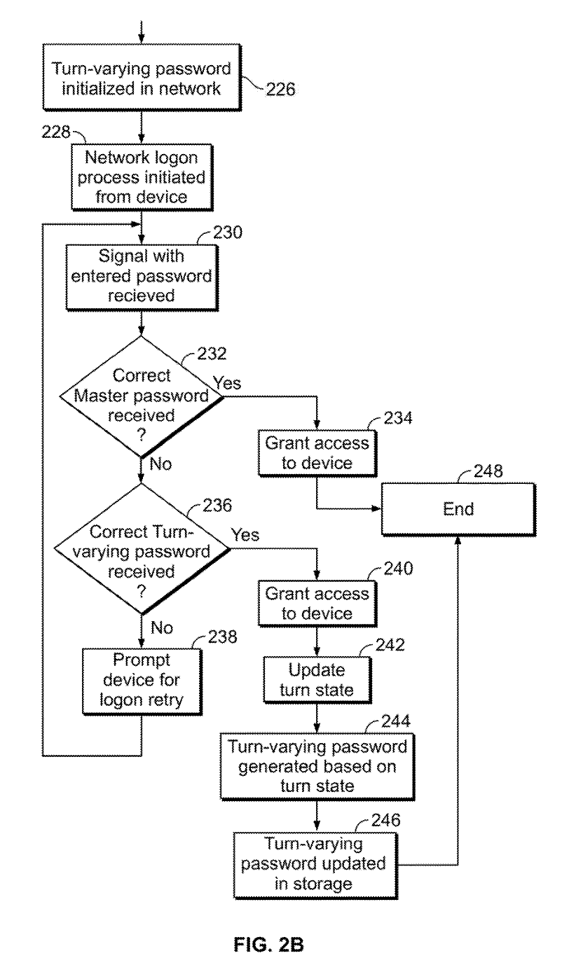

FIG. 3A is a flow diagram illustrating operations performed in a device/apparatus using the example circuitry of FIG. 1C. The operations in FIG. 3A may be performed as an implementation of operations 220, 222, and 224 of FIG. 2A in device 102, and operations 242, 244, and 246 of FIG. 2B in apparatus 120. In this implementation, each of password generator 106 (in device 102) and password generator 128 (in network apparatus 120) may include identical implementations of the circuitry of FIG. 1C.

The process of FIG. 3A may be described with reference to device 102 and FIGS. 1A and 1C. In device 102, at 302 an indication of a successful logon with the turn-varying password is received at password controller/monitor 110. At 304, password controller/monitor 110 cycles or shifts LFBSR 158 in password generator 106 by clocking input CK x times, where x may be 1 or any other predetermined number. At 306, password generator 106 maps the outputs of cycled LFBSR 158 through ASCII Mapper 160 to generate an updated turn-varying password at outputs P₁-P₈. Next, at 308, password controller/monitor 110 updates turn-varying password storage 108 by storing the updated turn-varying password on outputs P₁-P₈ in turn-varying password storage 108.

The process of FIG. 3A may be performed in network apparatus 120 similarly to what was described for device 102, except that the operations performed by password controller/monitor 110, password generator 128, and password generator 106 in device 102 would be performed by password controller/monitor 126, password generator 128, and password generator 128 in network apparatus 120.

FIG. 3B is a flow diagram illustrating operations performed in a device/apparatus using the example circuitry of FIG. 1B. The operations in FIG. 3B may be performed as an implementation of operations 220, 222, and 224 of FIG. 2A in device 102, and operations 242, 244, and 246 of FIG. 2B in network apparatus 120. In this implementation, each of password generator 106 (in device 102) and password generator 128 (in network apparatus 120) may include identical implementations of the circuitry of FIG. 1C.

The process of FIG. 3B may be described with reference to device 102 and FIGS. 1A and 1B. In device 102, at 312 an indication of a successful logon with the turn-varying password is received at password controller/monitor 110. At 314, password controller/monitor 110 updates a turn state by incrementing an index N. N may be incremented by 1 or any other predetermined number. At 316, password controller/monitor 110 retrieves an updated turn-varying password from database 155 in password generator 106 using the updated value of the index N. Next, at 308, password controller/monitor 110 updates turn-varying password storage 108 by storing the updated turn-varying password retrieved from password generator 128 in turn-varying password storage 108.

The process of FIG. 3B may be performed in network apparatus 120 similarly to what was described for device 102, except that the operations performed by password controller/monitor 110, password generator 128, and password generator 106 in device 102 would be performed by password controller/monitor 126, password generator 128, and password generator 128 in network apparatus 120.

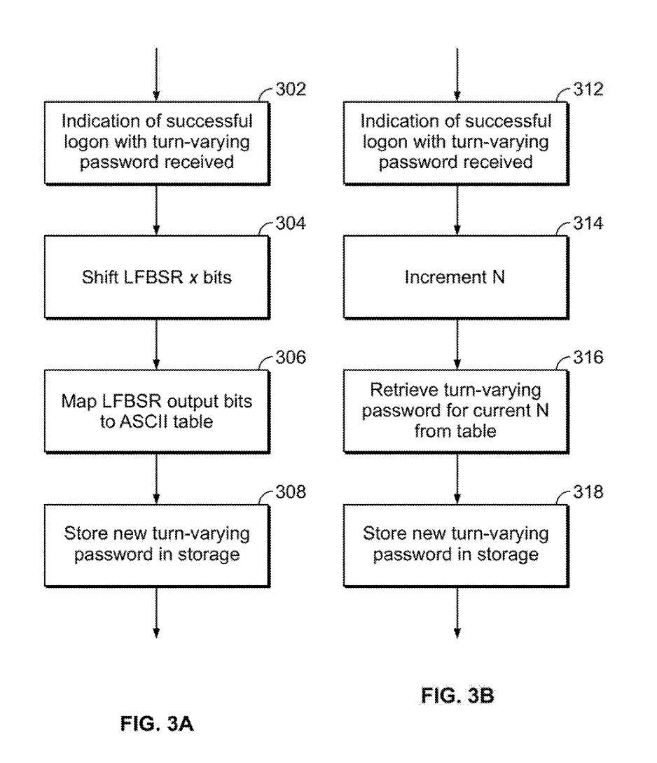

Referring now to FIG. 4, therein is a simplified block diagram of an example device 400. The functions of device 102 of FIG. 1A and FIG. 2A may be implemented on a device such as device 400. In example implementations, device 400 may be any type of device configured to communicate with a network to logon and access the network. For example, device 400 may be implemented in a smart phone, a tablet computer, a desktop computer, laptop computer device, gaming devices, an augmented reality (AR) device, media devices, smart televisions, multimedia cable/television boxes, smart phone accessory devices, tablet accessory devices, or personal digital assistants (PDAs).

Device 400 may include a processor 404, memory 408, user interfaces (U/IS) 406, and transceivers (TX/RX) 402. Transceivers TX/RX 402 may include, for example, Wideband CDMA/Long Term Evolution (WCDMA/LTE) transceivers, IEEE 802.11 Wi-Fi transceivers, short range transceivers such as Bluetooth or Wi-Fi direct transceivers, optical transceivers, or any other type of transceivers that allow communication with a network. In one example implementation transceivers TX/RX 402 may comprise circuitry that allows device 400 to communicate over cable or landline communication channels. User interfaces 406 may include any type of interface such as a touchscreen, a keypad, a voice controlled interface, interfaces that are gesture or motion based, an interface that receives input wirelessly, or any other type of interface that allows a user to perform logon to a network using turn-varying passwords according to the disclosed embodiments.

Memory 408 may he implemented as any type of computer read able storage media, including non-volatile and volatile memory. Memory 408 is shown as including code for device operating system (OS) 410, turn-varying password access applications 412, turn-varying password storage 414 and turn-varying password control/generation programs 416. Processor 404 may comprise one or more processors, or other control circuitry, or any combination of processors and control circuitry. Processor 404 provides overall control of device 400 by executing the code in memory 408 in to implement the functions for providing turn-varying passwords according to the disclosed embodiments. In implementations of device 400, processor 404 may execute code in memory 408 to execute the functions shown in FIGS. 1A, 1B, and 1C that are described in relation to FIG. 2A and FIGS. 3A and 3B. Operating system (OS) 410 provides overall control of device 102, including functions that may provide the network logon interfaces 104 of FIG. 1A. Turn-varying password access applications 412 may cause processor 404 to control device 400 to allow a user to request and receive a turn-varying password at a user interface such as user interface 112 of FIG. 1A. Turn-varying password storage 414 may provide the functions described for turn-varying password storage 108 of FIG. 1A. Turn-varying password control/generation programs 416 may provide the functions described for password controller/monitor 110 and password generator 106 of FIG. 1A.

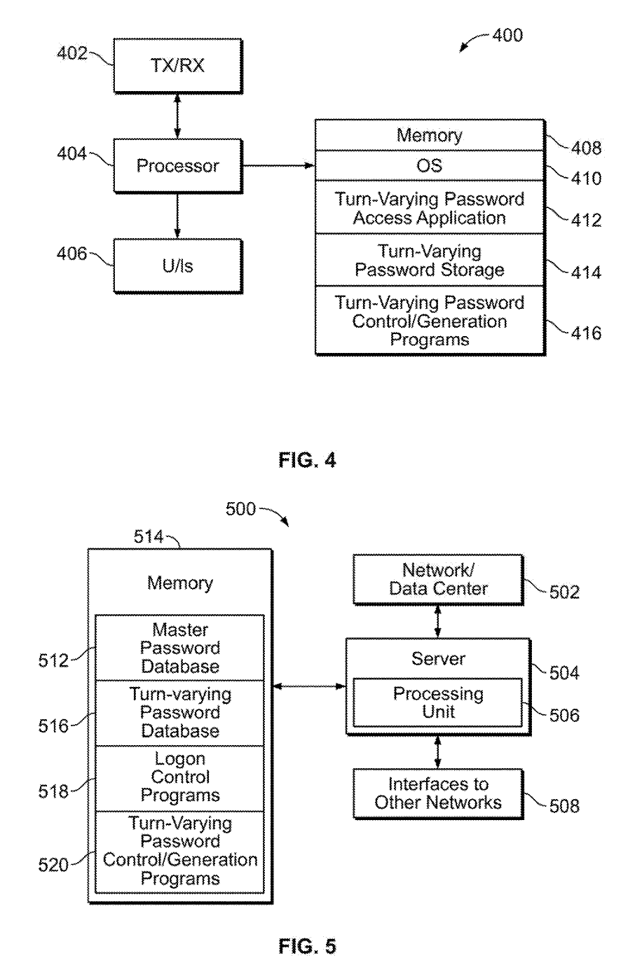

Referring now to FIG. 5, therein is a simplified block diagram of an example apparatus 500. The functions of apparatus 120 shown in FIG. 1A and FIG. 2A may be implemented on an apparatus such as apparatus 500. Apparatus 500 may be implemented in a network to control logon to the network or to a network service.

Apparatus 500 may include a server 504 having processing unit 506, a memory 514, interfaces to other networks 508, and Network/data center interfaces 502. The interfaces to other networks 508 allow communication between apparatus 120 and device 102 through, for example, the wireless system in which device 102 is operating. Network/data center interfaces 502 allow apparatus 120 to communicate with a network or data center that includes an account or service associated with a user's password. Memory 514 may be implemented as any type of computer readable storage media, including non-volatile and volatile memory. Memory 514 is shown as including master password data base 512, turn-varying password database 516, logon control programs 518, and turn-varying password control/generation programs 520. Server 504 and processing unit 506 may comprise one or more processors, or other control circuitry, or any combination of processors and control circuitry that provide overall control of controller 500 according to the disclosed embodiments.

Logon control programs 518 may cause processing unit 506 to control apparatus 500 to perform functions described for network logon controller 121 of FIG. 1A. Turn-varying password control/generation programs 520 may cause processing unit 506 to control apparatus to perform functions described for password controller/monitor 126 and password generator 128 of FIG. 1A. Master password database 512 and turn-varying password database 516 may provide, respectively, the functions described for master password storage 122 and turn-varying password storage 124 of FIG. 1A.

Apparatus 500 is shown as including server 504 as a single server. However, server 504 may be representative of server functions or server systems provided by one or more servers or computing devices that may be co-located or geographically dispersed to implement apparatus 500. The term server as used in this disclosure is used generally to include any computing devices or communications equipment that maybe implemented to perform logon using turn-varying passwords according to the disclosed embodiments.

The example embodiments disclosed herein may be described in the general context of processor-executable code or instructions stored on memory that may comprise one or more computer readable storage media (e.g., tangible non-transitory computer-readable storage media such as memory 408 or 514). As should be readily understood, the terms “computer-readable storage media” or “non-transitory computer-readable media” include the media for storing of data, code and program instructions, such as memory 408 or 514, and do not include portions of the media for storing transitory propagated or modulated data communication signals.

While implementations have been disclosed and described as having functions implemented on particular wireless devices operating in a network, one or more of the described functions for the devices may be implemented on a different one of the devices than shown in the figures, or on different types of equipment operating in different systems.

Embodiments have been disclosed that include a device comprising a user interface, one or more processors in communication with the user interface, and, memory in communication with the one or more processors, the memory comprising code that, when executed, causes the one or more processors to control the device to receive input at the user interface indicating a selected one of the turn-varying password or a master password for accessing the network, send a signal to access the network, the signal including the selected one of the turn-varying password or the master password, receive access to the network based on the selected one of the turn-varying password or the master password, and, if the network was accessed based on the turn varying-password, update a turn state in the device and update the turn-varying password based on the updated turn state. If the network was accessed based on the master password, the code may further cause the one or more processors to control the device to maintain the turn-varying password n the device. If the network was accessed based on the master password, the code may further cause the one or more processors to control the device to update the turn state in the device and update the turn varying password based on the updated state. The code may cause the one or more processors to receive input indicating the selected one of the turn-varying password or the master password at the user interface by controlling the device to receive a request at the user interface for the turn-varying password, provide the turn-varying password to a user at the user interface, and, receive the turn-varying password as input at the user interface. The code may cause the one or more processors to update the turn varying password in the device based on the turn state in response to receiving the request at the user interface for the turn-varying password.

The memory may further comprise an index and a database comprising iterations of the turn-varying password, and, if the network was accessed based on the turn varying-password, the device may update the turn state in the device by incrementing the index, and update the turn varying password by setting the turn-varying password to one of the iterations in the database associated with the incremented index. If the network was accessed based on the turn varying-password, the device may update the turn state in the device by cycling a password generator to generate an iteration of the turn-varying password, and update the turn-varying password by setting the turn-varying password to the iteration. The password generator may generate an iteration of the turn-varying password based on an initial seed value.

The disclosed embodiments also include an apparatus comprising one or more processors, and, memory in communication with the one or more processors, the memory comprising, a turn-varying password and a master password, each of the turn-varying password and the master password associated with a network user, the memory further comprising code that, when executed, causes the one or more processors to control the apparatus to receive a signal from a device for access to the network, the signal including a selected one of the turn-varying password or the master password, grant the device access to the network based on the selected one of the turn-varying password or the master password in the signal, and, if the network was accessed based on the turn-varying password, updating a turn state in the apparatus, updating the turn-varying password based on the updated turn state, and, maintaining the master password. If the network was accessed based on the master password, the code may further cause the one or more processors to control the apparatus to maintain the turn varying password in the apparatus. If the network was accessed based on the master password, the code may further cause the one or more processors to control the apparatus to update the turn state in the apparatus and update the turn varying password based on the updated state. The memory may further comprise an index and a database comprising iterations of the turn-varying password, and, if the network was accessed based on the turn varying-password, the apparatus may update the turn state in the device by incrementing the index and update the turn varying-password by setting the turn-varying password to one of the iterations in the database associated with the incremented index. If the network was accessed based on the turn varying-password, the apparatus may update the turn state in the device by cycling a password generator to generate an iteration of the turn-varying password, and update the turn-varying password by setting the turn-varying password to the iteration.

The disclosed embodiments also include a method comprising receiving input at a user interface of a device indicating a selected one of a turn-varying password or a master password for accessing a network, sending, from the device, a signal for access the network, the signal including the selected one of the turn-varying password or the master password, receiving, at the device, access to the network based on the one of the turn-varying password or the master password, and, if the access was based on the turn-varying password, updating a turn state in the device and updating the turn varying password in the device based on the updated turn state. The method may further comprise, if the access grant was based on the master password, maintaining the turn state in the device. The method may further comprise receiving a request at the user interface for the turn-varying password, providing the turn-varying password to a user at the user interface, and, receiving the turn-varying password as the input at the user interface. The receiving the request at the user interface for the turn-varying password may comprise receiving an access code. The updating the turn varying password in the device based on the turn state may comprise updating the turn-varying password in response to receiving the request at the user interface for the turn-varying password. The updating the turn state may comprise incrementing an index, and updating the turn-varying password may comprise setting the turn-varying password to one of a plurality of iterations associated with the incremented index in a database. The updating the turn state may comprise cycling a password generator to generate an iteration of the turn-varying password, and the updating the turn-varying password may comprise setting the turn-varying password to the generated iteration.

While the functionality disclosed herein has been described by illustrative example rising descriptions of the various components and devices of embodiments by referring to functional blocks and processors or processing units, controllers, and memory including instructions and code, the functions and processes of the embodiments may be implemented and performed using any appropriate functional blocks, type of processor, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLD s), etc. Use of the term processor or processing unit in this disclosure is meant to include all such implementations.

Also, although the subject matter has been described in language specific to structural features and/or methodological operations or acts, it is to be understood that the subject matter defined in the appended claims is not necessarily limited to the specific features, operations, or acts described above. Rather, the specific features, operations, and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may or combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A device comprising:
a user interface;
one or more processors in communication with the user interface; and,
memory in communication with the one or more processors, the memory comprising code that, when executed, causes the one or more processors to control the device to:
receive input at the user interface indicating a selected one of the turn-varying password or a master password for accessing the network;
send a signal to access the network, the signal including the selected one of the turn-varying password or the master password;
receive access to the network based on the selected one of the turn-varying password or the master password; and,
if the network was accessed based on the turn varying-password:
update a turn state in the device; and,
update the turn-varying password based on the updated turn state.

2. The device of claim 1, wherein, if the network was accessed based on the master password, the code further causes the one or more processors to control the device to maintain the turn-varying password in the device.

3. The device of claim 1, wherein, if the network was accessed based on the master password, the code further causes the one or more processors to control the device to update the turn state in the device and update the turn varying password based on the updated state.

4. The device of claim 1, wherein the code causes the one or more processors to receive input indicating the selected one of the turn-varying password or the master password at the user interface by controlling the device to:
receive a request at the user interface for the turn-varying password;
provide the turn-varying password to a user at the user interface; and,
receive the turn-varying password as input at the user interface.

5. The device of claim 4, wherein the code causes the one or more processors to update the turn varying password in the device based on the turn state in response to receiving the request at the user interface for the turn-varying password.

6. The device of claim 1, wherein the memory further comprises an index and a database comprising iterations of the turn-varying password, and, if the network was accessed based on the turn varying-password, the device updates the turn state in the device by incrementing the index, and updates the turn varying password by setting the turn-varying password to one of the iterations in the database associated with the incremented index.

7. The device of claim 1, wherein, if the network was accessed based on the turn varying-password, the device updates the turn state in the device by cycling a password generator to generate an iteration of the turn-varying password, and updates the turn-varying password by setting the turn-varying password to the iteration.

8. The device of claim 7, wherein the password generator generates an iteration of the turn-varying password based on an initial seed value.

9. An apparatus comprising:
one or more processors; and,
memory in communication with the one or more processors, the memory comprising, a turn-varying password and a master password, each of the turn-varying password and the master password associated with a user of a network, the memory further comprising code that, when executed, causes the one or more processors to control the apparatus to:
receive a signal from a device for access to the network, the signal including a selected one of the turn-varying password or the master password;
grant the device access to the network based on the selected one of the turn-varying password or the master password in the signal; and,
if the network was accessed based on the turn-varying password:
updating a turn state in the apparatus;
updating the turn-varying password based on the updated turn state; and,
maintaining the master password.

10. The apparatus of claim 9, wherein, if the network was accessed based on the master password, the code further causes the one or more processors to control the apparatus to maintain the turn varying password in the apparatus.

11. The apparatus of claim 9, wherein, if the network was accessed based on the master password, the code further causes the one or more processors to control the apparatus to update the turn state in the apparatus and update the turn varying password based on the updated state.

12. The apparatus of claim 9, wherein the memory further comprises an index and a database comprising iterations of the turn-varying password, and, if the network was accessed based on the turn varying-password, the apparatus updates the turn state in the apparatus by incrementing the index and updates the turn varying-password by setting the turn-varying password to one of the iterations in the database associated with the incremented index.

13. The apparatus of claim 9, wherein, if the network was accessed based on the turn varying-password, the apparatus updates the turn state in the apparatus by cycling a password generator to generate an iteration of the turn-varying password, and updates the turn-varying password by setting the turn-varying password to the iteration.

14. A method comprising:
receiving input at a user interface of a device indicating a selected one of a turn-varying password or a master password for accessing a network;
sending, from the device, a signal for access the network, the signal including the selected one of the turn-varying password or the master password;
receiving, at the device, access to the network based on the one of the turn-varying password or the master password; and,
if the access was based on the turn varying-password:
updating a turn state in the device; and,
updating the turn varying password in the device based on the updated turn state.

15. The method of claim 14, further comprising, if the access grant was based on the master password, maintaining the turn state in the device.

16. The method of claim 14, further comprising:
receiving a request at the user interface for the turn-varying password;
providing the turn-varying password to a user at the user interface; and,
receiving the turn-varying password as the input at the user interface.

17. The method of claim 16, wherein the receiving the request at the user interface for the turn-varying password comprises receiving an access code.

18. The method of claim 16, wherein the updating the turn-varying password in the device based on the turn state comprises updating the turn-varying password in response to receiving the request at the user interface for the turn-varying password.

19. The method of claim 14, wherein updating the turn state comprises incrementing an index, and updating the turn-varying password comprises setting the turn-varying password to one of a plurality of iterations associated with the incremented index in a database.

20. The method of claim 14, wherein updating the turn state comprises cycling a password generator to generate an iteration of the turn-varying password, and updating the turn-varying password comprises setting the turn-varying password to the generated iteration.
